(19) United States
(12) Patent Application Publication
(10) Pub. No.: US 2025/0253720 A1
(43) Pub. Date: Aug. 7, 2025

(54) STATOR AND MOTOR

(71) Applicant: NIDEC CORPORATION, Kyoto (JP)

(72) Inventors: Yoshitsugu SASAGURI, Kyoto (JP); Kenji FUKAMI, Kyoto (JP); Kazuya KITAJI, Kyoto (JP); Kosuke NIIMI, Kyoto (JP)

(21) Appl. No.: 19/043,629

(22) Filed: Feb. 3, 2025

(30) Foreign Application Priority Data
Feb. 7, 2024 (JP) 2024-017263

(51) Int. Cl. H02K 1/16

(52) U.S. Cl. CPC H02K 1/165; H02K 2213/03

(57) ABSTRACT

A stator includes a core back, teeth, and a coil. The core back has an annular shape surrounding the central axis in a circumferential direction. The teeth extend radially outward from the core back, and are arranged in the circumferential direction. The coil is wound around each of the teeth. In the coil, a current of any phase of three-phase alternating current flows. At least a portion of an extending line connecting a first coil wound around a first tooth among the teeth and a second coil through which a current having the same phase as that of the first coil flows is located in a slot between any two of the teeth except the first tooth and a second tooth located adjacent to the first tooth. The extending line is at a root of any of the two teeth in the slot.

### CROSS-REFERENCE TO RELATED APPLICATIONS

The present application claims priority under 35 U.S.C. § 119 to Japanese Patent Application No. 2024-017263, filed on Feb. 7, 2024, the entire contents of which are hereby incorporated herein by reference.

### 1. Field of the Invention

The present disclosure relates to stators and motors.

### 2. Background

In a conventional small spindle motor, three-phase stator coils are disposed in an annular core of a stator.

In the small spindle motor of the related art, the three wires forming the three-phase stator coils respectively pass through a plurality of slots arranged between the stator coils and are output from any one of the slots. Therefore, since the lengths of the three lines become longer and the electrical resistance increases, there is a possibility that a copper loss increases.

### SUMMARY

An example embodiment of a stator of the present disclosure includes a core back, a plurality of teeth, and a coil. The core back has an annular shape surrounding a central axis in a circumferential direction. The plurality of teeth extend radially outward from the core back, and are arranged in the circumferential direction. The coil is wound around each of the plurality of teeth. In the coil, a current of any phase of three-phase alternating current flows. At least a portion of an extending line connecting a first coil wound around a first tooth among the plurality of teeth and a second coil through which a current having a same phase as that of the first coil flows is located in a slot between any two of the plurality of teeth except the first tooth and a second tooth adjacent to the first tooth. The extending line is positioned at a root of any of the two teeth in the slot.

An example embodiment of a motor of the present disclosure includes the stator, a shaft, and a rotor. The shaft extends along the central axis. The rotor rotates with respect to the stator.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram illustrating a cross section along a rotation axis of a motor 1 according to a first example embodiment of the present disclosure.

FIG. 2 illustrates the stator 10 of the motor 1 as viewed from one axial side Z1.

FIG. 3 is a plan view illustrating the stator 10 in a state in which a coil 123 is wound.

FIG. 4 is an enlarged view of two adjacent teeth 122 of the stator 10.

FIG. 5 is illustrates how to wind the coil 123 corresponding to the U phase.

FIG. 6 is illustrates how to wind the coil 123 corresponding to the V phase.

FIG. 7 illustrates how to wind the coil 123 corresponding to the W phase.

### DETAILED DESCRIPTION

Hereinafter, example embodiments of the present disclosure will be described with reference to the accompanying drawings. Note that, in the drawings, the same or corresponding parts are denoted by the same reference numeral and description of such parts will not be repeated. In the present specification, for easy understanding, a direction substantially parallel to a rotation axis of a motor is described as an axial direction Z, one side in the axial direction Z is described as one axial side 21, and another side in the axial direction Z is described as the other axial side Z2. Further, a radial direction around the axial direction Z is described as a radial direction R, and a circumferential direction around the axial direction Z is described as a circumferential direction C. However, the direction is defined merely for convenience of description, and the orientation at the time of use of a stator or a motor according to the present disclosure is not limited unless it is particularly necessary to define a horizontal direction and a vertical direction. In addition, an “orthogonal direction” in the present disclosure includes a substantially orthogonal direction.

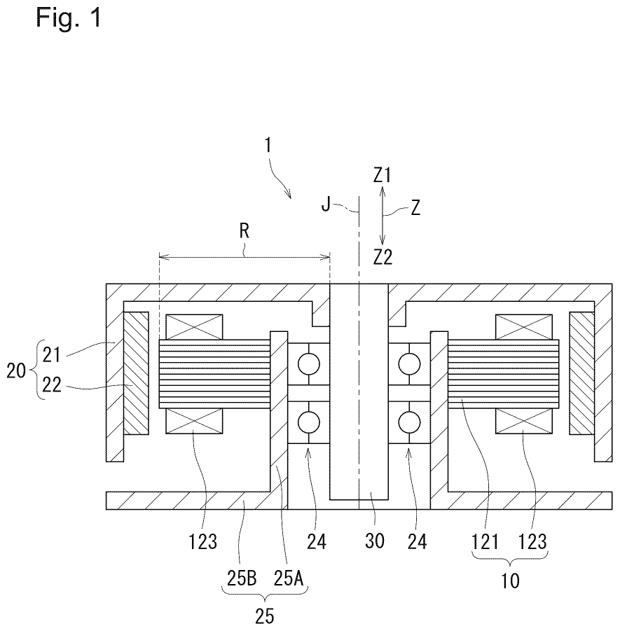

A first example embodiment of a motor 1 will be described with reference to FIG. 1. FIG. 1 is a diagram illustrating a cross section along a rotation axis of the motor 1 according to the first example embodiment.

As an example, the motor 1 is mounted on a drone. Typically, the motor 1 is used as a motor that rotates a propeller of a drone.

As illustrated in FIG. 1, the motor 1 includes a shaft 30 as a rotation axis, a stator 10, a rotor 20, and a bearing 24. When the motor 1 is mounted on a drone, the shaft 30 is fixed to the rotor 20 and constitutes a rotation axis of the propeller. The stator 10 has an annular shape. The rotor 20 rotates relative to the stator 10. In the present example embodiment, the rotor 20 surrounds the outer periphery of the stator 10 in the radial direction R and covers one axial side Z1 of the stator 10.

Specifically, the rotor 20 includes a yoke 21 and a plurality of magnets 22. Typically, the yoke 21 is a cylindrical, or annular, iron member surrounding the outer periphery of the stator 10. On an inner peripheral surface of the yoke 21, a plurality of the magnets 22 are arranged along the inner peripheral surface. Specifically, N poles and S poles of a plurality of the magnets 22 are alternately arranged in the circumferential direction C on the inner peripheral surface of the yoke 21. The magnet 22 is constituted of, for example, a rectangular parallelepiped permanent magnet. In the example embodiment, a plurality of magnets are arranged side by side, but one annular magnet in which N poles and S poles are alternately arranged may also be used.

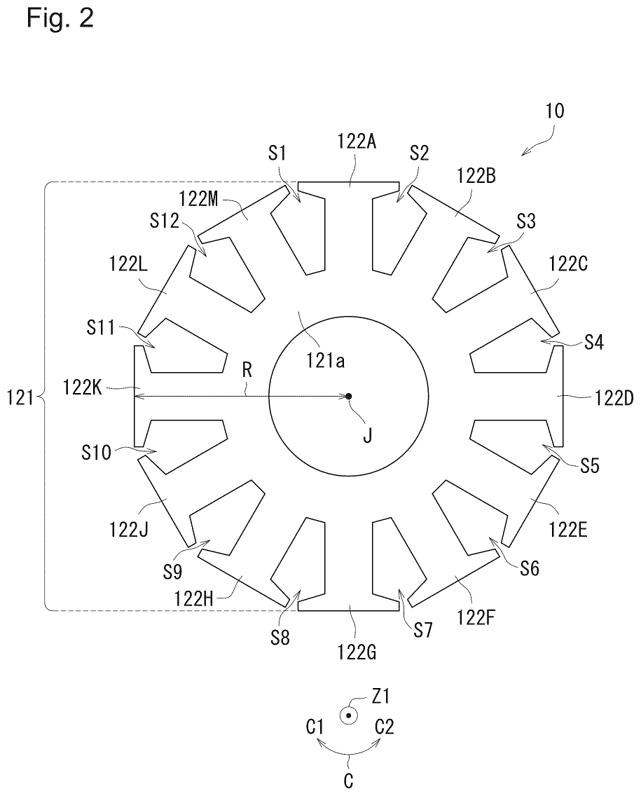

Next, the stator 10 of the first example embodiment will be described with reference to FIGS. 1 and 2. FIG. 2 is a plan view illustrating the stator 10 of the first example embodiment. FIG. 2 illustrates the stator 10 as viewed from one axial side Z1. FIG. 2 illustrates the stator 10 in a state where the coil 123 is not disposed.

The stator 10 includes a stator core 121 and a coil 123. As illustrated in FIG. 1, the stator core 121 has an annular shape and is disposed inside the magnet 22 in the radial direction R with a gap interposed therebetween. Specifically, the stator core 121 is rotatably attached to the shaft 30 via a bracket 25 and the bearing 24. For example, the outer diameter of the stator core 121 is 35 mm to 40 mm. The bracket 25 includes a cylindrical portion 25A having a cylindrical shape and located inside the stator core 121 in the radial direction R, and a cover portion 25B connected to the cylindrical portion 25A and covering the other axial side Z2 of the stator core 121. The outer peripheral surface of the cylindrical portion 25A is in contact with the inner peripheral surface of the stator core 121. The bearing 24 is attached to the inner peripheral surface of the cylindrical portion 25A. That is, the center of the stator core 121 coincides with the center of the cylindrical portion 25A. As a result, the center of the stator core 121 substantially coincides with a central axis J of the shaft 30. Therefore, the rotor 20 rotates around the stator 10 together with the shaft 30 with the shaft 30 as an axis.

As illustrated in FIG. 1, the stator core 121 is formed of a plurality of core members stacked in the axial direction Z. The core member is formed of, for example, an electromagnetic steel plate. As illustrated in FIG. 2, the stator core 121 includes a core back 121a and twelve teeth 122A to 122M. Hereinafter, each of the teeth 122A to 122M may be referred to as a tooth 122. By providing twelve teeth 122, it is possible to balance suppression of cogging torque and securing of a space for winding the coil 123 between the teeth 122.

The core back 121a and the tooth 122 are integrally formed. The core back 121a surrounds the central axis j of the shaft 30 in the circumferential direction C, and is formed in an annular shape. Each of the teeth 122 extends outward in the radial direction R from an outer surface in the radial direction R of the core back 121a. The teeth 122A to 122M are arranged in order in a clockwise direction C1 at equal intervals along the circumferential direction C when viewed from the one axial side Z1.

A slot S, which is a gap in which the coil 123 and the like are located, is formed between the teeth 122. Specifically, a slot S2 is formed between the teeth 122A and 122B. A slot S3 is formed between the teeth 122B and 122C. A slot S4 is formed between the teeth 122C and 122D. A slot S5 is formed between the teeth 122D and 122E. A slot S6 is formed between the teeth 122E and 122F. A slot S7 is formed between the teeth 122F and 122G. A slot S8 is formed between the teeth 122G and 122H. A slot S9 is formed between the teeth 122H and 122J. A slot S10 is formed between the teeth 122J and 122K. A slot S11 is formed between the teeth 122K and 122L. A slot S12 is formed between the teeth 122L and 122M. A slot S1 is formed between the teeth 122M and 122A.

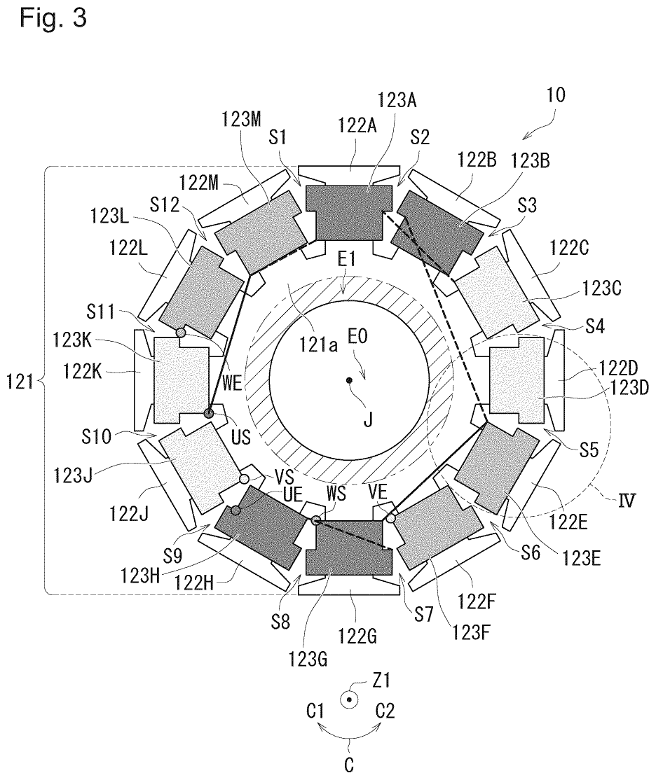

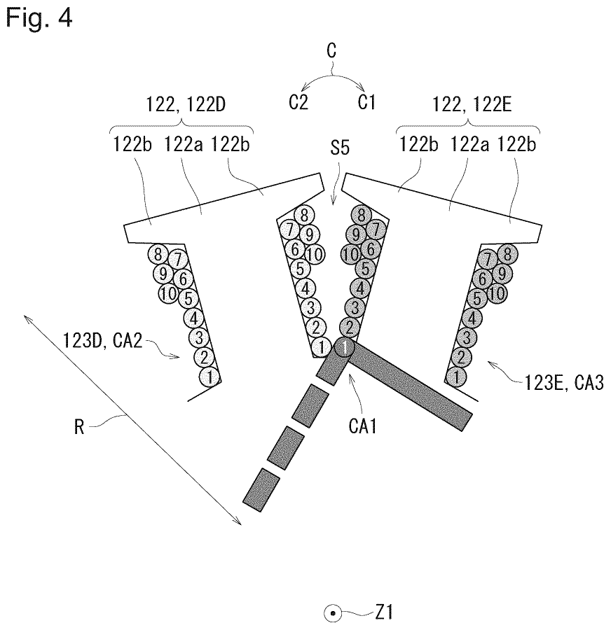

Next, the stator 10 in a state in which the coil 123 is wound will be described with reference to FIGS. 3 and 4. FIG. 3 is a plan view illustrating the stator 10 in a state in which the coil 123 is wound. FIG. 4 is an enlarged view of two adjacent teeth 122 of the stator 10. FIG. 4 representatively shows a tooth 122D and a tooth 122E.

The coil 123 is mounted on the teeth 122A to 122M. Specifically, the coil 123 is formed by winding a conductive wire CA around each of the teeth 122. The conductive wire CA is a cable formed of a string-like conductor and an insulating film covering the periphery of the conductor. Hereinafter, a portion of the conductive wire CA where the coil 123 is not formed may be referred to as an “extending line”.

Coils 123 corresponding to any phase of the three-phase alternating current are wound around the teeth 122A to 122M. In the present example embodiment, the coil 123A, the coil 123B, the coil 123G, and the coil 123H corresponding to the U phase among the three phases are arranged on the tooth 122A, the tooth 122B, the tooth 122G, and the tooth 122 H, respectively. In other words, a U-phase current of the three-phase alternating current flows through the coil 123A, the coil 123B, the coil 123G, and the coil 123H. The coil 123A and the coil 123B are arranged adjacent to each other. The coil 123G is disposed on the opposite side of the coil 123A across the central axis J. The coil 123H is disposed on the opposite side of the coil 123B across the central axis J.

A coil 123C, a coil 123D, a coil 123 J, and a coil 123K corresponding to the V phase among the three phases are arranged on the tooth 122C, the tooth 122D, the tooth 122J, and the tooth 122K, respectively. A V-phase current of the three-phase alternating current flows through the coil 123C, the coil 123D, the coil 123J, and the coil 123K. The coil 123C and the coil 123D are arranged adjacent to each other. The coil 123J is disposed on the opposite side of the coil 123C across the central axis J. The coil 123K is disposed on the opposite side of the coil 123D across the central axis J.

A coil 123E, a coil 123F, a coil 123L, and a coil 123M corresponding to the W phase among the three phases are arranged on the tooth 122E, the tooth 122F, the tooth 122L, and the tooth 122M, respectively. A W-phase current t of the three-phase alternating current flows through the coil 123E, the coil 123F, the coil 123L, and the coil 123M. The coil 123E and the coil 123F are arranged adjacent to each other. The coil 123L is disposed on the opposite side of the coil 123E across the central axis J. The coil 123M is disposed on the opposite side of the coil 123F across the central axis J.

As illustrated in FIG. 4, the tooth 122 includes a column portion 122a and a pair of protrusions 122b. The column portion 122a has a columnar shape and extends outward in the radial direction R from the core back 121a. Hereinafter, of the teeth 122 and the column portion 122a in the radial direction R, the core back 121a side is referred to as a root side, and the side opposite to the root side is referred to as a tip side. The pair of protrusions 122b are protrusions protruding in the clockwise C1 direction and the counterclockwise C2 direction in the circumferential direction C from the tip side of the column portion 122a.

The coil 123 is provided on the column portion 122a. Specifically, the coil 123 is formed by winding the conductive wire CA around the column portion 122a. In the present example embodiment, the conductive wire CA is first wound from the root side toward the tip side of the column portion 122a, and when the conductive wire CA reaches the protrusion 122b, the conductive wire CA is further wound from the outside of the conductive wire CA wound around the column portion 122a toward the root side. In FIG. 4, the winding order of the conductive wire CA is indicated by numbers from 1 to 10. Hereinafter, the case where the number of windings of the conductive wire CA per coil 123 is ten will be representatively described.

In the present example embodiment, the end of the coil 123 is located outside the center position of the tooth 122 in the radial direction R. Since the width the slot S is wider on the tip side than on the root side of the teeth 122, the number of windings of the coil 123 can be easily increased by arranging the end of the coil 123 on the tip side.

For example, the wire diameter of the conductive wire CA is 0.5 mm to 0.9 mm. As a result, it is possible to enhance the heat dissipation of the conductive wire CA and suppress an increase in the resistance value accompanying a temperature rise. As a result, the motor 1 including the stator 10 can obtain good torque characteristics in a high-speed range.

In addition, by using the conductive wire CA having a wire diameter of 0.5 mm to 0.9 mm, favorable torque characteristics can be obtained even in the case of the coil 123 in which the conductive wire CA wound around the tooth 122 is formed with the number of windings of ten or less.

As a result, since the coil 123 is formed with a small number of windings, the number of layers of the conductive wire CA wound around the tooth can be two or less. Therefore, since the volume of the coil 123 is reduced, the stator 10 can be formed more compactly.

In the present example embodiment, the number of windings of the conductive wire CA per coil 123 is not particularly limited, and for example, the number of windings of the conductive wire CA per coil 123 may be twenty or less. By making the number of windings of the coil 123 larger than ten, the magnetic force of the coil 123 increases, and the torque of the rotor 20 can be further increased.

In the present example embodiment, the coil 123A, the coil 123B, the coil 123G, and the coil 123H corresponding to the U phase are formed by one conductive wire CA1. The U-phase coil 123A, the coil 123B, the coil 123G, and the coil 123H are formed by one conductive wire CA1. The coil 123C, the coil 123D, the coil 123J, and the coil 123K corresponding to the V phase are formed by one conductive wire CA2. The coil 123E, the coil 123F, the coil 123L, and the coil 123M corresponding to the W phase are formed by one conductive wire CA3.

Hereinafter, the case of the U-phase will be representatively described. The same applies to the V phase and the W phase as the U phase. For example, in the case where the coil 123A, the coil 123B, the coil 123G, and the coil 123H are formed by one conductive wire CA1, for example, when the conductive wire CA1 is passed from the coil 123B to the coil 123G, it is necessary to avoid a region E0 on the inner side in the radial direction R with respect to the inner peripheral surface of the stator core 121.

Therefore, in the present example embodiment, the conductive wire CA1 is passed from the coil 123B to the coil 123G via one or more slots S. Typically, the conductive wire CA1 passes through any one of the slots S5 to S12 formed between any two of the teeth 122 among the teeth 122 D to 122M excluding the tooth 122B in which the coil 123B is disposed and the teeth 122A and 122C disposed adjacent to the tooth 122B among the teeth 122A to 122M. In this case, the tooth 122B on which the coil 123B is disposed is an example of a first tooth. The teeth 122A and 122C each located on both sides of the tooth 122B are examples of second teeth. The tooth 122G on which the coil 123G having the same phase as the coil 123B is disposed is an example of a third tooth.

As a result, in addition to the region E0, the conductive wire CA1 can avoid a region E1 within a predetermined range on the outer side in the radial direction R from the inner peripheral surface of the core back 121a. As a result, the mounting jig used for mounting the cylindrical portion 25A to the stator core 121 can be mounted in the region E1, and the possibility of contact between the mounting jig and the coil 123 can be reduced. For example, the region E1 preferably occupies ½ or more of the width of the core back 121a in the radial direction R. Further, the region E1 more preferably occupies ⅔ or more of the width of the core back 121a in the radial direction R.

For example, as illustrated in FIGS. 3 and 4, the conductive wire CA forming the coil 123B and the coil 123G corresponding to the U phase passes through the slot S5 formed between the tooth 122D in which the coil 123D corresponding to the V phase is disposed and the tooth 122E in which the coil 123E corresponding to the W phase is disposed.

Specifically, the conductive wire CA1 extends from the winding end position of the coil 123B in the slot S2 to the slot S5 along the surface on the other axial side Z2 of the stator core 121, extends to the surface on the one axial side Z1 of the stator core 121 through the slot S5, extends from the slot S5 along the surface on the one axial side Z1 of the stator core 121, and reaches the winding end position of the coil 123G in the slot S7. In FIGS. 3 and 4, a solid line indicates that the conductive wire CA1 is located on the surface on the one axial side Z1, and a broken line indicates that the conductive wire CA1 is located on the surface on the other axial side Z2.

By passing through only the slot S5 from the coil 123B to the coil 123G, the movement of the conductive wire CA1 between both surfaces of the stator core 121 in the axial direction Z is reduced, and the conductive wire CA1 can be passed from the coil 123B to the coil 123G at a short distance. Therefore, the stator 10 provided with the plurality of coils 123 can be formed compactly without using an insulator. In addition, since the electric resistance of the entire coil 123 decreases, the stator core 121 has good magnetic characteristics. As a result, the motor 1 including the stator core 121 is a highly efficient motor in which an increase in copper loss is suppressed, good torque characteristics are obtained in a high-speed range, and loss is suppressed.

In addition, since the conductive wire CA1 can also be connected to the coil 123G disposed at the position facing the coil 123B in the radial direction R, specifically, the coil 123G adjacent to the coil 123H located at the position farthest from the coil 123B only through the slot S5, the conductive wire CA1 can be further shortened.

At this time, the conductive wire CA1 is located on the root side of the tooth 122E in the slot S5 instead of the conductive wire CA3 forming the coil 123E. By arranging the conductive wire CA1 on the root side of the tooth 122E, the conductive wire CA1 can be passed from the coil 123B to the coil 123G at a short distance without hindering the formation of the coil 123E. When the conductive wire CA1 passes through the slot S5, the conductive wire CA1 may be disposed not on the root side of the tooth 122E but on the root side of the tooth 122D.

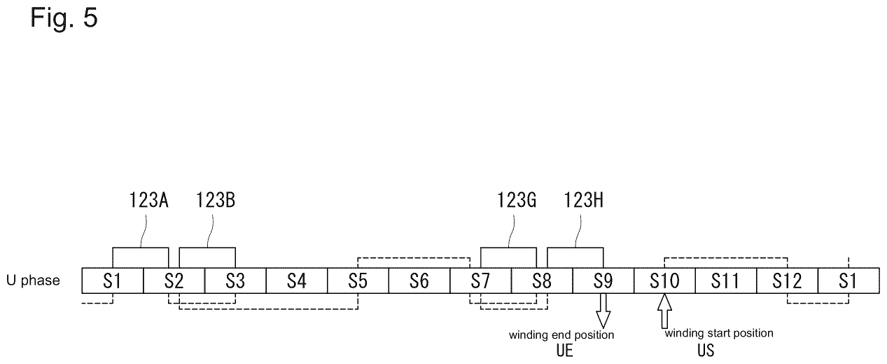

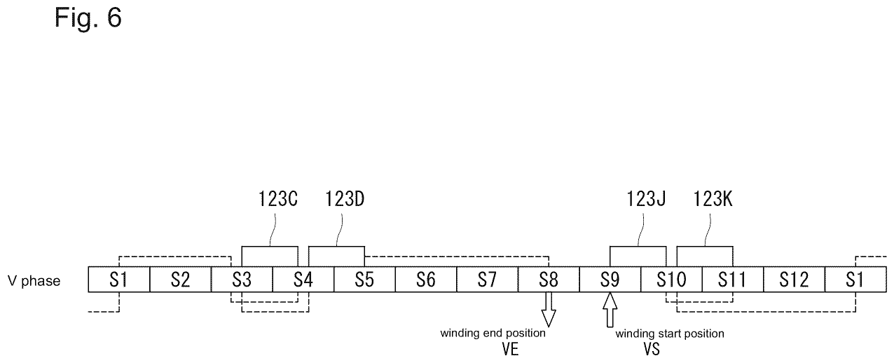

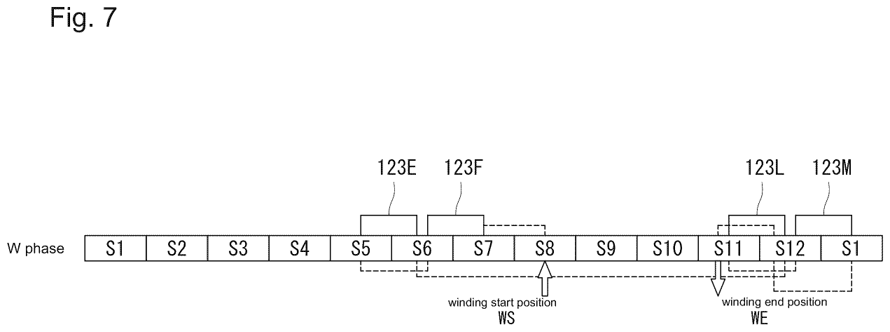

Next, how to wind the coil 123 corresponding to each of the U phase, the V phase, and the W phase will be described with reference to FIGS. 5 to 7. FIG. 5 illustrates how to wind the coil 123 corresponding to the U phase. FIG. 6 illustrates how to wind the coil 123 corresponding to the V phase. FIG. 7 illustrates how to wind the coil 123 corresponding to the W phase.

As illustrated in FIG. 5, a winding start position US of the conductive wire CA1 forming the coil 123A, the coil 123B, the coil 123G, and the coil 123H corresponding to the U phase is the other axial side Z2 of the slot S10. The conductive wire CA1 first passes through the slot S10 and extends to the slot S12 along the surface on the one axial side Z1. Then, the conductive wire CA1 passes through the slot S12 and extends to the slot S1 along the surface on the other axial side 22 of the stator core 121. Then, the conductive wire CA1 is wound around the tooth 122A (FIG. 3) located adjacent to the slot S1 to form the coil 123A. Then, the conductive wire CA1 extends from the winding end of the coil 123A in the slot S2 to the slot S3 along the surface on the other axial side Z2 of the stator core 121. Then, the conductive wire CA1 is wound around the tooth 122B (FIG. 3) located adjacent to the slot S3 to form the coil 123B. Then, the conductive wire CA1 extends from the winding end of the coil 123B in the slot S2 to the slot S5 along the surface on the other axial side Z2 of the stator core 121. Then, the conductive wire CA1 passes through the slot S5 and extends to the slot S7 along the surface on the one axial side Z1 of the stator core 121. Then, the conductive wire CA1 passes through the slot S7 and extends to the slot S8 along the surface on the other axial side Z2. Then, the conductive wire CA1 is wound around the tooth 122G (FIG. 3) located adjacent to the slot S8 to form the coil 123G. Then, the conductive wire CA1 extends from the winding end of the coil 123G in the slot S7 to the slot S8 along the surface on the other axial side Z2 of the stator core 121. Then, the conductive wire CA1 is wound around the tooth 122H (FIG. 3) located adjacent to the slot S8 to form the coil 123H. The conductive wire CA1 is drawn out from the winding end of the coil 123H in the slot S9 to the other axial side Z2. That is, the winding end of the coil 123H in the slot S9 is a winding end position UE of the conductive wire CA1.

As illustrated in FIG. 6, a winding start position VS of the conductive wire CA2 forming the coil 123C, the coil 123D, the coil 123J, and the coil 123K corresponding to the V phase is the other axial side Z2 of the slot S9. First, the conductive wire CA2 is wound around the tooth 122J (FIG. 3) located adjacent to the slot S9 to form the coil 123J. Then, the conductive wire CA2 extends from the winding end of the coil 123J in the slot S10 to the slot S11 along the surface on the other axial side Z2 of the stator core 121. Then, the conductive wire CA2 is wound around the tooth 122K (FIG. 3) located adjacent to the slot S11 to form the coil 123K. Then, the conductive wire CA2 extends from the winding end of the coil 123K in the slot S10 to the slot S1 along the surface on the other axial side 22 of the stator core 121. Then, the conductive wire CA2 passes through the slot S1 and extends to the slot S3 along the surface on the one axial side Z1 of the stator core 121. Then, the conductive wire CA2 is wound around the tooth 122C (FIG. 3) located adjacent to the slot S3 to form the coil 123C. Then, the conductive wire CA2 extends from the winding end of the coil 123C in the slot S3 to the slot S4 along the surface on the other axial side Z2 of the stator core 121. Then, the conductive wire CA2 is wound around the tooth 122D (FIG. 3) located adjacent to the slot S4 to form the coil 123D. Then, the conductive wire CA2 extends from the winding end of the coil 123D in the slot S4 to the slot S7 along the surface on the one axial side Z1 of the stator core 121. Then, the conductive wire CA2 passes through the slot S7 and is drawn out to the other axial side Z2. That is, a winding end position VE of the conductive wire CA2 is located in the slot S7.

As illustrated in FIG. 7, a winding start position WS of the conductive wire CA3 forming the coil 123E, the coil 123F, the coil 123L, and the coil 123M corresponding to the W phase is the other axial side Z2 of the slot S8. First, the conductive wire CA3 passes through the slot S8 and extends to the slot S7 along the surface on the one axial side Z1 of the stator core 121. Then, the conductive wire CA3 is wound around the tooth 122F (FIG. 3) located adjacent to the slot S7 to form the coil 123F. Then, the conductive wire CA3 extends from the winding end of the coil 123F in the slot S6 to the slot S5 along the surface on the other axial side Z2 of the stator core 121. Then, the conductive wire CA3 is wound around the tooth 122E (FIG. 3) located adjacent to the slot S5 to form the coil 123E. Then, the conductive wire CA3 extends from the winding end of the coil 123E in the slot S6 to the slot S12 along the surface on the other axial side 22 of the stator core 121. Then, the conductive wire CA3 is wound around the tooth 122L (FIG. 3) located adjacent to the slot S12 to form the coil 123L. Then, the conductive wire CA3 extends from the winding end of the coil 123L in the slot S11 to the slot S12 along the surface on the other axial side Z2 of the stator core 121. Then, the conductive wire CA3 is wound around the tooth 122M (FIG. 3) located adjacent to the slot S12 to form the coil 123M. Then, the conductive wire CA3 extends from the winding end of the coil 123M in the slot S1 to the slot S12 along the surface on the other axial side Z2 of the stator core 121. Then, the conductive wire CA3 passes through the slot S12 and extends to the slot S11 along the surface on the one axial side Z1 of the stator core 121. Then, the conductive wire CA3 passes through the slot S11 and is drawn out to the other axial side 22. That is, a winding end position WE of the conductive wire CA3 is located in the slot S11.

FIGS. 3 and 4 to 7 illustrate the winding start position US of the conductive wire CA1, the winding end position UE of the conductive wire CA1, the winding start position VS of the conductive wire CA2, the winding end position VE of the conductive wire CA2, the winding start position WS of the conductive wire CA3, and the winding end position WE of the conductive wire CA3. In the present example embodiment, the winding start position of at least one conductive wire CA of the conductive wire CA1, the conductive wire CA2, and the conductive wire CA3 is located in a slot S other than the slot S in which the winding start position or the winding end position of each of the other two conductive wires CA is located. In addition, the winding end position of at least one conductive wire CA of the conductive wire CA1, the conductive wire CA2, and the conductive wire CA3 is located in a slot S other than the slot S in which the winding start position or the winding end position of each of the other two conductive wires CA is located.

Typically, the winding start position of the finally wound conductive wire CA among the conductive wire CA1, the conductive wire CA2, and the conductive wire CA3 is located in a slot S other than the slot S in which the winding start position or the winding end position of each of the other two conductive wires CA is located, and the winding end position is located in a slot S other than the slot S in which the winding start position or the winding end position of each of the other two conductive wires CA is located.

As a result, the number of “extending lines” positioned in each slot S is two or less. By setting the number of “extending lines” extending from each slot S to two or less, the “extending line” are not biased to a specific slot. Therefore, the stator 10 is easily attached to the rotor 20 and the shaft 30.

The “extending line” extends from the slots S7 to S11 arranged side by side. As described above, since the slot S in which the “extending line” extends is biased to a part in the circumferential direction C, it is possible to reduce the space required for connection when connecting the wiring outside the motor 1 to the “extending line”.

In the present example embodiment, the plurality of coils 123 corresponding to the same phase are formed of one conductive wire CA, but the present disclosure is not limited thereto, and the plurality of coils 123 may be formed of different conductive wires CA, and the coils 123 may be connected to each other by different conductive wires CA. In this case, the conductive wire CA connecting the coils 123 is an “extending line”.

In the present example embodiment, the number of the teeth 122 arranged in the stator core 121 and the arrangement of the phases of the coils 123 arranged in the teeth 122 are not particularly limited. Specifically, the number of teeth 122 may be six, nine, or fifteen or more. In the arrangement of the coils 123, three phases may be alternately arranged, or a set of a plurality of coils 123 corresponding to one phase may be sequentially arranged along the circumferential direction C.

The example embodiment of the present disclosure is described above with reference to the drawings. However, the present disclosure is not limited to the above example embodiment, and can be implemented in various modes without departing from the gist of the present disclosure. Further, a plurality of constituent elements disclosed in the above example embodiment can be appropriately modified. For example, a certain constituent element of all constituent elements illustrated in a certain example embodiment may be added to constituent elements of another example embodiment, some or constituent elements of all constituent elements illustrated in a certain example embodiment may be removed from the example embodiment.

Further, the drawings schematically illustrate each constituent element mainly in order to facilitate understanding of the disclosure, and the thickness, length, number, interval, and the like of the illustrated constituent elements may be different from the actual ones for convenience of creation of the drawings. The configuration of each component shown in the above example embodiment is an example and is not particularly limited, and it goes without saying that various modifications can be made without substantially departing from the effects of the present disclosure.

The present technology can have the following configurations.
(1) A stator including a core back with an annular shape surrounding a central axis in a circumferential direction, a plurality of teeth extending radially outward from the core back and arranged in the circumferential direction, and a coil wound around each of the plurality of teeth, wherein a current of any phase of three-phase alternating current flows through the coil, at least a portion of an extending line connecting a first coil wound around a first tooth of the plurality of teeth and a second coil through which a current having a same phase as the phase of the first coil flows is located in a slot between any two of the plurality of teeth except the first tooth and a second tooth adjacent to the first tooth, and the extending line is located at a root of any of the two of the plurality of teeth in the slot.
(2) The stator according to (1), wherein the extending line is wired to avoid a region within a predetermined range on an outer side in the radial direction from an inner peripheral surface of the core back.
(3) The stator according to (1) or (2), wherein a third tooth on which the second coil is located and the first tooth oppose each other in the radial direction.
(4) The stator according to any one of (1) to (3), wherein twelve of the teeth are provided.
(5) The stator according to any one of (1) to (4), wherein an end of the coil is located outside a center position of each of the plurality of teeth in the radial direction.
(6) The stator according to any one of (1) to (5), wherein the coil is wound around each of the plurality of teeth in two or less layers.
(7) The stator according to any one of (1) to (6), wherein a number of turns of the coil is ten or less.
(8) The stator according to any one of (1) to (7), wherein a number of the extending lines located in the slot is two or less.
(9) A motor including a stator according to any one of (1) to (8), a shaft extending along the central axis, and a rotor that is rotatable with respect to the stator.
(10) The motor according to (9), wherein the rotor surrounds an outer periphery of the stator in the radial direction.

Example embodiments of the present disclosure is applicable to the field of motors.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A stator comprising:
a core back with an annular shape surrounding a central axis in a circumferential direction;
a plurality of teeth extending radially outward from the core back and arranged in the circumferential direction; and
a coil wound around each of the plurality of teeth; wherein
a current of any phase of three-phase alternating current flows through the coil;
at least a portion of an extending line connecting a first coil wound around a first tooth of the plurality of teeth and a second coil through which a current with a same phase as a phase of the first coil flows is located in a slot between any two of the plurality of teeth except the first tooth and a second tooth adjacent to the first tooth; and
the extending line is located at a root of any of the two of the plurality of teeth in the slot.

2. The stator according to claim 1, wherein the extending line is wired to avoid a region within a predetermined range on an outer side in the radial direction from an inner peripheral surface of the core back.

3. The stator according to claim 1, wherein a third tooth on which the second coil is located and the first tooth oppose each other in the radial direction.

4. The stator according to claim 3, wherein twelve of the teeth are provided.

5. The stator according to claim 1, wherein an end of the coil is located outside a center position of each of the plurality of teeth in the radial direction.

6. The stator according to claim 5, wherein the coil is wound around each of the plurality of teeth in two or less layers.

7. The stator according to claim 5, wherein a number of turns of the coil is twenty or less.

8. The stator according to claim 1, wherein a number of the extending lines located in the slot is two or less.

9. A motor comprising:
the stator according to claim 1;
a shaft extending along the central axis; and
a rotor that is rotatable with respect to the stator.

10. The motor according to claim 9, wherein the rotor surrounds an outer periphery of the stator in the radial direction.
